(19) United States
(12) Patent Application Publication
(10) Pub. No.: US 2021/0295176 A1
(43) Pub. Date: Sep. 23, 2021

(54) METHOD AND SYSTEM FOR GENERATING ROBUST SOLUTIONS TO OPTIMIZATION PROBLEMS USING MACHINE LEARNING

(71) Applicant: NEC Laboratories Europe GmbH, Heidelberg (DE)

(72) Inventors: Tobias Jacobs, Mannheim (DE); Guelcin Ermis, Heidelberg (DE); Francesco Alesiani, Heidelberg (DE)

(21) Appl. No.: 16/924,213

(22) Filed: Jul. 9, 2020

Related U.S. Application Data
(60) Provisional application No. 62/990,457, filed on Mar. 17, 2020.

(51) Int. Cl. G06N 5/00; G06N 20/00

(52) U.S. Cl. CPC G06N 5/003; G06N 20/00

(57) ABSTRACT

A method for generating robust solutions to optimization problems using machine learning includes receiving an instance of an optimization problem. A solution to the instance is computed using a model. A cost-maximizing environment realization is generated for the solution. A cost of the solution in the cost-maximizing environment realization for the solution is used as feedback to update the model.

### CROSS-REFERENCE TO PRIOR APPLICATION

Priority is claimed to U.S. Provisional Patent Application No. 62/990,457 filed on Mar. 17, 2020, the entire disclosure of which is hereby incorporated by reference herein.

### STATEMENT REGARDING SPONSORED RESEARCH

The project leading to this application has received funding from the European Union's Horizon 2020 research and innovation programme under grant agreement No 769141.

### FIELD

The present invention relates to a method and system for applying machine learning in combination with mathematical optimization to obtain robust solutions to optimization problems. The method and system can be applied to optimization problems such as those in logistics and other technical fields.

### BACKGROUND

Computational tools that are used to perform optimization in logistics rely on input data that has been collected before-hand from sources that are not always reliable. For example, customers who commission pick-up and delivery services for a set of items can fail to correctly specify the item sizes. Furthermore, some of the data is fed by prediction models (e.g. estimating the number of items in a warehouse at a specific future time) and those predictions are likely to contain errors. As a result, during execution of plans that have previously been computed by optimization tools, it can happen that the plan is not executable anymore (e.g., because the total size of items will not fit into the planned transporters due to misspecification of sizes).

Robust optimization is an approach to deal with this type of uncertainty about the environment during the planning/optimization stage. Instead of assuming all data to be 100% correct during planning, a robustness region around the data is defined. For example, it could be assumed that 50% of the items to be shipped deviate by at most 20% from their specified size, while 20% of the items might deviate by up to 50%.

The target of robust optimization is to determine the solution which performs best in the worst case realization of the environment (within the given uncertainty region). One of the challenges in robust optimization is its computational complexity. In general, due to having much more computational complexity, it requires significantly more computational resources to compute an optimal robust solution than to compute an optimal solution without robustness.

Combinatorial approaches for optimally or approximately solving robust optimization problems rely on re-formulating the problem to eliminate the uncertainties. These re-formulations are highly problem-specific, and they are also only applicable for restricted types of uncertainty regions. Other re-formulations are costly to compute, the computation has to be re-applied for every new problem instance and no generalization from known problem instances to unseen instances takes place (see, e.g., Kawase, Yasushi, et al., “Randomized strategies for robust combinatorial optimization,” Proceedings of the AAAI Conference on Artificial Intelligence, Vol. 33 (2019), and Pinto, Lerrel, et al., “Robust adversarial reinforcement learning,” Proceedings of the 34th International Conference on Machine Learning, Vol. 70 (2017), each of which is hereby incorporated by reference herein).

U.S. Pat. No. 10,522,036 uses robust reinforcement learning as a mechanism to deal with uncertainties, where an optimizer agent learns to generate solutions which are then evaluated using another learning agent to find the worst-case environment realization. In this case, two agents are trained interdependently using reinforcement learning, which the inventors have recognized can lead to instabilities of the overall learning system as the target against which the learning takes place is constantly changing.

### SUMMARY

In an embodiment, the present invention provides a method for generating robust solutions to optimization problems using machine learning. The method includes the steps of: a) receiving an instance of an optimization problem; b) computing a solution to the instance using a model; c) generating a cost-maximizing environment realization for the solution; and d) using a cost of the solution in the cost-maximizing environment realization for the solution as feedback to update the model.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically shows a method and system architecture for reinforcement learning training according to an embodiment of the present invention; and

FIG. 2 schematically shows a method and system architecture for reinforcement learning training according to an embodiment of the present invention which uses an instance history database and an environment history database;

FIG. 3 graphically shows results in terms of worst-case cost on instances of various sizes for a first problem comparing the agent according to an embodiment of the present invention against two baselines;

FIG. 4 graphically shows training progress in terms of cost for the agent according to an embodiment of the present invention in terms of average test costs for the first problem with 90-100 nodes;

FIG. 5 graphically shows training progress in terms of average return for the agent according to an embodiment of the present invention in terms of average test costs for the first problem with 90-100 nodes;

FIG. 6 graphically shows results of applying the agents trained for the first problem on various data set sizes; and

FIG. 7 graphically shows results in terms of worst-case cost on instances of various sizes for a second problem comparing the agent according to an embodiment of the present invention against two baselines.

### DETAILED DESCRIPTION

Embodiments of the present invention provide a machine learning-based method and system for generating robust solutions to optimization problems, such as logistics problems. The system combines mathematical solvers, such as linear programming (LP) solvers, and reinforcement learning (RL) methods in a novel way, where the solver is responsible to act as an adversary which destabilizes the solutions generated by an RL agent. The RL agent receives feedback from the destabilized performance and thereby learns to generate solutions that are robust against such instabilities.

Embodiments of the present invention employ a combination of a machine learning technique and mathematical optimization which results in a system which (a) generates near-optimal robust solutions, (b) generates solutions to unseen problem instances fast (after training), and (c) is generically applicable to a wide range of optimization problems in logistics. Accordingly, embodiments of the present invention provide a method and system which provides a number of improvements to technology, for example, by being flexible to solve a number of different technical problems in different technical fields, such as logistics, providing optimal or near-optimal robust solutions faster while saving computational power and resources, and being able to be applied quickly even in the case of unseen problem instances, in addition to being robust against instabilities. In contrast to a set-up in which the adversary is also an RL agent, embodiments of the present invention are able to provide for more reliable training which reaches convergence faster with less steps and reduced computational power and resource usage. Also, in contrast to approximate or exact optimization methods which have to be repeated for each new problem instance, the RL agent trained in accordance with embodiments of the present invention can be deployed for a number of different new and unseen optimization problems without being trained specifically for these problems, but still obtain solutions that are optimal or near-optimal and yet also robust against instabilities. Since the RL agent can be deployed for these new and unseen problems without requiring further training, the solutions are also generated quickly and efficiently, consuming significantly less computational resources to arrive at the solutions.

In an embodiment, the present invention provides a method for generating robust solutions to optimization problems using machine learning. The method includes the steps of: a) receiving an instance of an optimization problem; b) computing a solution to the instance using a model; c) generating a cost-maximizing environment realization for the solution; and d) using a cost of the solution in the cost-maximizing environment realization for the solution as feedback to update the model.

In an embodiment, steps a)-d) are repeated to train the model until convergence is reached.

In an embodiment, the method further comprises deploying the trained model to generate solutions to new problem instances.

In an embodiment, the cost-maximizing environment realization for the solution is determined using a supervised learning model for at least some of the iterations of step c), and wherein the supervised learning model has been trained using input-output pairs including uncertainties of the optimization problem and different solutions to the optimization problem as input and cost-maximizing environment realizations for the different solutions to the optimization problem as output.

In an embodiment, the method further comprises determining the instance for at least some of the iterations of step a) using a history of problem instances stored in an instances history database.

In an embodiment, at least some of the instances are generated using a generative model trained using the history of problem instances stored in an instances history database.

In an embodiment, the method further comprises repeating steps a) and b) and tracking a state for the solution, wherein, for at least some of the iterations of steps a) and b), the solution is a partial solution to the instance of the optimization problem.

In an embodiment, the feedback is a reward of zero until a full solution to the instance is obtained, at which point the feedback is a negative reward based on the cost of the solution in the cost-maximizing environment realization for the solution.

In an embodiment, the solution is a partial solution, the method further comprising using a frozen version of the model to generate remaining steps to a full solution, wherein the feedback for the partial solution is the cost of the full solution in the cost-maximizing environment realization for the full solution.

In an embodiment, the optimization problem is a logistics problem. In an embodiment, the method further comprises: selecting a vehicle to be an active vehicle; selecting a demand in the instance; modifying the instance based on whether the active vehicle has sufficient capacity for the demand; and using Monte-Carlo rollouts to provide the feedback.

In an embodiment, the method further comprises using a heuristic to generate a default solution, wherein a cost difference between a cost of the default solution in a cost-maximizing environment realization for the default solution and the cost of the solution in the cost-maximizing environment realization for the solution is used as the feedback.

In an embodiment, the cost-maximizing environment realization for the solution is formulated as a linear problem and determined using a linear programming solver.

In another embodiment, the present invention provides a computer system for training a reinforcement learning agent to generate robust solutions to optimization problems using machine learning, the system comprising one or more hardware processors which, alone or in combination, are configured to provide for execution of the following steps: a) receiving an instance of an optimization problem; b) computing a solution to the instance using a model; c) generating a cost-maximizing environment realization for the solution; and d) using a cost of the solution in the cost-maximizing environment realization for the solution as feedback to update the model. The computer system can also be configured to provide for other steps of embodiments of the method.

In a further embodiment, a tangible, non-transitory computer-readable medium having instructions thereon which, upon being executed by one or more processors, alone or in combination, provide for execution of a method according to any embodiment of the present invention.

The logistics problem of planning the pickup and delivery of a number of items is used as a running example to illustrate an embodiment of the present invention. Each item has a specified size, but it is known that up to 50% of the items can have a size up to 20% smaller or larger than specified, and up to 20% of the items can have a size which is up to 50% larger than specified. There is no way of knowing which of the items come with these deviations.

To formalize the descriptions, let E be the set of possible environment realizations, let S be the set of possible solutions, and let cost(s,e) be the cost of a particular solution s E S under a particular environment realization e∈E. The objective is to find:

$${min}_{s ∈ S} {max}_{e ∈ E} cost ( s , e )$$

In the running example, the set E consists of all possible deviations from the specified packet sizes, S is the set of all pickup and delivery schedules for the items, and cost(s,e) is the total cost caused by the schedule (fuel, personnel, etc.), including also penalties in cases where the schedule is not fully executable and some packets remain not picked up or not delivered.

This problem can be viewed as a two-agent game. Agent 1 (also called optimizer) is trying to minimize the cost function by providing a solution s given the environment E. The optimizer's choice of the solution s takes into account agent 2 (also called adversary), which will choose an environment realization e from the set of environments E to maximize the cost under the solution s provided by the optimizer. The task is to develop a strategy for the optimizer agent. The agents can be realized by a combination of software running on hardware, the hardware including one or more servers, computational processors coupled to memory and the like, and each of agents can maintain their own internal model(s). The devices of the agents are configured by code to perform their respective functions discussed herein.

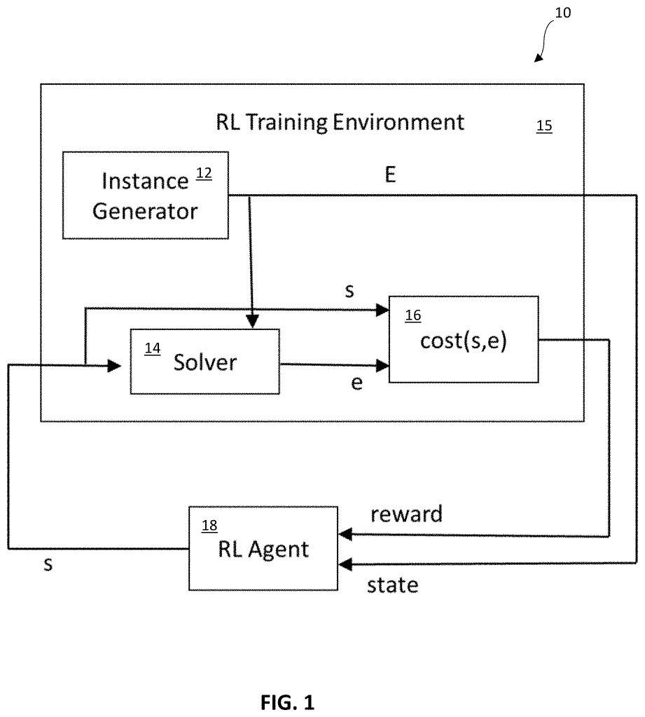

Referring to FIG. 1, a method and system architecture 10 for training an optimizer agent according to an embodiment of the present invention is shown. According to an embodiment of the present invention, the optimizer agent is realized as a RL agent 18, while the adversary is realized by a solver 14 solving mathematical programs (e.g., linear programs). As usual in RL, the RL agent 18 selects actions (here: solutions) and receives state information and rewards in return. Inside the RL agent 18, a learning algorithm is analyzing the past experience of states, actions and rewards to learn an action selection policy represented by the internal model of the RL agent 18 which maximizes the reward received.

The RL training environment 15 in the method and system architecture 10 includes three components. The instance generator 12 generates environments (including the uncertainty regions) and passes them to the RL agent 18 as observations. The solver 14, e.g. an LP solver, receives the solution s generated by the RL agent 18 and finds an environment realization e maximizing the cost. To this end, the optimization problem

$${max}_{e ∈ E} cost ( s , e )$$

for the given solution s has to be solved. As uncertainty regions are usually continuous, the maximization problem can typically be formulated as a linear program without integer decision variables, which admits to find optimal solutions quickly even for large problems with millions of variables. Thus, it is especially advantageous if the solver is configured to solve linear programs. Finally, an evaluation component 16 in the RL training environment 15 determines the cost of the solution s from the RL agent 18 under the environment realization e computed by the solver 14 and returns this cost as a (negative) reward to the RL agent 18, which is used by the RL agent 18 to update its internal model. According to an embodiment of the present invention, the solver 14 and the evaluation component 16 can be a single component which determined the cost-maximizing environment realization and the cost associated therewith.

In the running example, the instance generator 12 generates instances of the optimization problem, consisting of the set of packets, the set of available vehicles, and the road network, including specifications of the uncertainty range around the packet sizes. The optimizer RL agent 18 generates a pickup and delivery schedule. The solver 14 takes this schedule as an input and finds the realization of packet sizes where the schedule causes maximum cost. The cost of that schedule is then passed as a (negative) reward to the RL agent 18.

For applying the RL agent 18 after training, the adversary solver 14 is not required anymore. Given an environment, the trained RL agent 18 computes a robust solution in a single application of its internal model (typically, in a single forward pass of its internal Neural Network). The environment is preferably given as part of the optimization problem definition. It can either be explicitly represented as part of the problem instance description, or it can be used by the training environment and never explicitly given to the RL agent 18. Since the RL agent 18 provides a model or a parametrization of a function, such as the weights of the internal Neural Network, the same machine on which the RL agent 18 was trained does not have to be the same machine that is deployed. Rather, the machine that is deployed can apply the trained model of the RL agent 18.

Embodiments of the present invention cover the following extensions and variations:

(1) Training and environment design choices: It is not necessary that the RL agent 18 generates a full solution in a single step. The action space can be designed such that each action corresponds to one single decision (e.g., which packet to pick up next), so that after a certain number of steps a full solution is found. In this case, a component of the environment, preferably the solver 14 and/or evaluation component 16 can modify the state after each step, marking the steps that have already been taken by the RL agent 18 (RL agents are in general stateless, so they require some form of information about the steps they have already taken). As for the reward that is passed to the RL agent 18, there are several possibilities as follows:
a. The environment can shape the reward function by passing a reward of zero after each non-final step, and passing the negated cost from the solver's environment realization only after the final step. This realization is compatible with the Q-learning algorithm with temporal difference updates for training the RL agent 18.
b. The environment can, after a step of the RL agent 18, first use a frozen version of the RL agent 18 to generate the remaining steps to the full solution, and then pass the resulting cost to the RL agent 18 as feedback with regard to the original step. This realization corresponds to Q-learning with Monte-Carlo rollouts.
   (2) Instance generation: In practical scenarios, a history of past problem instances might be available instead of an explicit distribution from which the instance generator 12 could generate the instances. In this case, those past instances can be used to train the RL agent 18. From the past instances, a generative model can also be trained, which is then used to provide additional training instances.
   (3) Solver Model: The solver 14 computes a function where the input is a problem instance with uncertainties E and a solution s, and the output is an instance realization e. After having generated multiple such input-output pairs, a supervised learning model can be trained as an approximate version of the solver 14. As soon as the approximate model has reached sufficient accuracy, it can replace the solver 14. Depending on the nature of the cost maximization problem, the approximate model would provide advantages such as requiring less computational resources. This is because solvers typically do a lot of trial-and-error to find a good or optimal solution to the given problem. In contrast, the supervised learning model is trained with a number of problem-solution pairs, learning a function which maps from problems to the corresponding solution. After training, this function is then applied to new problem instances, which is much faster than a trial-and-error process.
   (4) Providing differential feedback to the RL agent 18: Here, the environment, preferably the solver 14 and/or evaluation component 16, uses a heuristic to generate default solutions, and the RL agent 18 attempts to improve upon the heuristic. The reward passed to the RL agent 18 is then set to the cost difference between the RL agent's choice and the heuristic solution. For example, the solver 14 and/or evaluation component 16 determines the maximum cost for the heuristic solution and the maximum cost for the solution of the RL agent 18 and uses this difference as the reward. In other words, the default solution is generated by the heuristic, the worst-case cost of the default solution is computed, the worst-case cost of the agent's solution is computed and the difference between these two worst case costs, that is, the improvement of the agent upon the default, is used as feedback for training the RL agent 18. When using this approach in combination with the RL agent 18 providing single steps instead of full solutions as output, the heuristic can be applied to complete the partial solution generated by the RL agent 18, and the immediate reward is then set to the improvement by the single steps of the RL agent 18 over the step previously applied by the heuristic.
   (5) Hyperparameter tuning of the solver 14: Because the solver 14 is applied during training a large number of times for similar problem instances, a systematic exploration process for the solver configuration parameters (e.g., solution search strategy) and their influence on the solver resource requirements can be implemented, such that the most resource-efficient solver configuration is found and thus the training progress is accelerated.

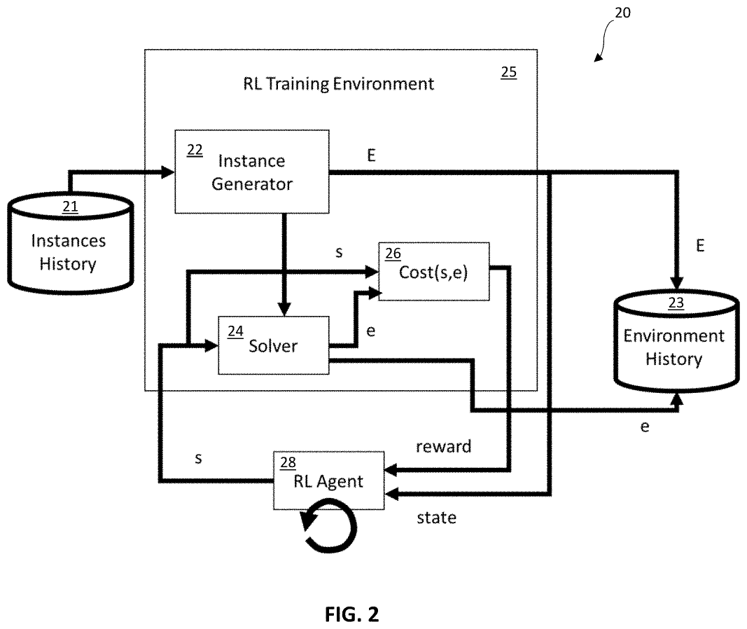

FIG. 2 illustrates a method and system architecture 20 of an extended version in which the RL training environment 25 has an instance generator 22 that uses an instances history database 21 to generate training instances (see point (1) above), and in which the solver 24 makes use of an environment history database 23, where problem instances, corresponding solutions, and instance realizations are stored to train the supervised learning model which approximates the solver 24 (see point (2) above). The solver 24 and/or evaluation component 26 determines the cost for an environment e that maximizes the cost of the solution s from the RL agent 28, and passes this case back to the RL agent as a (negative) reward. In this embodiment, the RL agent 28 is configured to be trained using Monte-Carlo rollouts.

According to an embodiment of the present invention, capacitated vehicle routing with demand variations is addressed using the RL agent 28 trained with Monte-Carlo rollouts. This embodiment is a refinement of the previous running example. The logistics problem of planning the pickup of a number of items and their delivery to a warehouse with a number of vehicles is considered. All vehicles have the same capacity, and each item has a specified size, but it is known that up to 50% of the items can have a size up to 20% smaller or larger than specified, and up to 20% of the items can have a size which is up to 50% larger than specified.

There is an instances history database 21 containing instances of that problem that had to be solved in the past. In each episode, the instance generator 22 randomly picks one of these instances and passes it to the RL agent 28. Since in this embodiment the robustness region is the same for each instance (see preceding paragraph), the robustness region does not have to be encoded explicitly by the instance generator 22. The following is an example of pseudocode of a method according to an embodiment of the present invention:

Main loop:

| | |
|---|---|
| - | For each episode 1...n |

| ◯ | Instance generator 22 randomly picks an instance from the instances history |
|---|---|
| | database 21. |
| ◯ | Some vehicle is chosen to be the active vehicle. |
| ◯ | The instance is passed to the RL agent 28. |
| ◯ | While there is some unsatisfied demand in the instance: |

| ▪ | The RL agent 28 selects one demand in the instance and passes it back |
|---|---|
| | to the environment. |
| ▪ | The environment, preferably the solver 24 and/or evaluation |

component 26, modifies the problem instance by interpreting the
agent's action:

| | |
|---|---|
| ● | IF the active vehicle has enough capacity for the demand: |

| | |
|---|---|
| ◯ | The environment plans this demand to be picked up by |

the active vehicle.

| | |
|---|---|
| ● | ELSE |

| ◯ | The active vehicle returns to the depot and a new |
|---|---|
| | vehicle is chosen as the active one. |
| ◯ | The new active vehicle is planned to pick up the |

demand.

| | |
|---|---|
| ● | The environment is modified by removing the served demand |

and modifying the vehicle capacities accordingly.

| ▪ | The instance generator 21 and the RL agent 28 perform a number of |
|---|---|
| | Monte-Carlo rollouts to determine the value of the RL agent's choice. |
| ▪ | The value from the Monte-Carlo rollouts and the modified problem |
| | instance are passed to the RL agent 28. |
| ▪ | The RL agent 28 uses the feedback to update its internal models. |

Monte-Carlo rollouts:

| | |
|---|---|
| - | Input: instance where some demands are already satisfied. |
| - | for each rollout-episode 1 ... m: [note: in case of deterministic agents, a single rollout |

suffices].

| | |
|---|---|
| ◯ | While there is unsatisfied demand: |

| ▪ | The instance is passed to the RL agent 28. |
|---|---|
| ▪ | The RL agent 28 selects one demand in the instance and passes it back |
| | to the environment. |
| ▪ | The environment modifies the problem instances (see procedure |

above).

The cost of the current rollout is computed using the solver 24 solving a linear maximization problem and the evaluation component 26 determining the cost given the worst-case environment realization from the solver 24. As indicated above, the solver 24 and the evaluation component 26 can be combined in to a single machine or component.
Output: The averaged negated cost over all rollouts.

Embodiments of the present invention have the following applications:
Route planning in autonomous driving (shortest paths with robustness against traffic jams). Here, the learning optimizer RL agent generates routes for vehicles, while the mathematical programming adversary computes worst-case traffic jam situations that lead to high route costs and/or the violation of constraints.
Operations planning in fully automated container terminals (robustness against uncertain demand predictions and delays of particular operations). Here, the learning optimizer RL agent generates hourly plans for loading and unloading container ships and cargo trains, and adapts these plans in case of new events like demands or delays. The plans are made robust against changes by the mathematical programming adversary computing worst-case events under the given plan and using them as feedback for the RL agent.
Buffer management in network devices (robustness against unforeseen peak loads). Here, the learning optimizer RL agent makes buffer management decisions like selecting packets for forwarding or dropping packets, whereas the mathematical programming adversary computes worst-case packet arrival sequences during the training phase to make the RL agent robust.
Multi-modal cargo shipment planning (robustness against delays and cancellations of cargo ships and trains). Here, the learning optimizer RL agent generates plans to ship cargo between the pickup and the delivery location, using combinations of multiple modes of transport. The mathematical programming adversary computes a set of train or ship cancellations and delays so as to generate the highest possible routing costs and arrival delays.
Staff roster planning (robustness against sickness and other unforeseen events). Here, the learning optimizer RL agent generates rostering plans for staff, while the mathematical programming adversary computes worst-case events like sickness of late arrival of staff to minimize the degree of task fulfilment.
Supply chain management (robustness against failures or delays). Here, the learning optimizer RL agent plans ordering of goods given predictions about sales rates and production rates, while the mathematical programming adversary computes worst-case deviations from the predictions to maximize the number of missed and/or delayed sales.

Embodiments of the present invention provide for some or all of the following improvements and advantages:

1) Using a combination of reinforcement learning and mathematical programming to train an agent to generate near-optimal robust solutions to logistics optimization problems.
2) Training an approximate version of the adversary (solver) using supervised learning to speed up the overall training process.
3) Using differential feedback for the RL agent in comparison to a heuristic, which is used both to compute a baseline solution for comparison and to complete the partial solution provided by the RL agent.
4) Using a history of past instances as the basis to provide training problem instances.
5) Training a generative model built from historical problem instances, which is then used to provide training problem instances.
6) Exploring the configuration parameter space of the solver to find the most resource-efficient configuration, further speeding up the overall training progress.
7) Ability to generate robust solutions (as compared to standard reinforcement learning for optimization).
8) Ability to converge faster and more reliably during training (as compared to setups where the adversary is an RL agent as well).
9) General applicability to a wide range of optimization problems (as compared to approximate and exact optimization methods which have to be repeated for each new problem instance).

According to an embodiment of the present invention, a method for training and deploying an RL agent to generate robust solutions comprises the steps of:

1) The instance generator generating an instance.
2) The RL agent receiving the instance, and computing a solution.
3) The solver taking the solution of the RL agent, and generating a cost-maximizing environment realization.
4) The RL agent using the cost of this realization as a feedback signal to improve its internal models.
5) Steps 1-4 are executed multiple times until RL the agent has converged.
6) The RL agent is deployed to generate robust near-optimal solutions to new and unseen problem instances.

In the following, particular embodiments of the present invention are described, along with experimental results illustrating computational improvements achieved. To some extent, the following description uses different terminology or symbols to refer to the same components or notations which are used in embodiments of the present invention described above, but would be understood by ordinarily skilled artisans as referring to the same or similar components or notations.

Embodiments of the present invention provide a methodology to learn robust heuristics for optimization problem by combining robust optimization and robust reinforcement learning, proposing a methodology to learn robust heuristics for optimization problems. In real-world applications like logistics, large-scale combinatorial problems have to be solved under uncertainty about the correctness of the problem specification parameters. Robust optimization addresses this problem by computing solutions that have strong worst-case guarantees as long as the true problem parameters lie within a prespecified uncertainty region. Embodiments of the present invention provide a mechanism to automatically learn heuristics that are robust to perturbations of the problem specification. Existing non-robust heuristics for the problem at hand can be plugged in to provide guidance during training, and an agent learns to improve upon the given heuristic, taking into account feedback from pessimistic evaluations of the generated solutions. In a series of experiments with instances of capacitated vehicle routing and traveling salesperson, the performance of the approach according to embodiments of the present invention was validated, demonstrating that the trained agents are able to outperform heuristics for robust optimization in terms of the worst-case costs.

In logistics and other application areas of computational optimization, robustness is an important property of planners and optimizers, which due to complexity are necessarily computer systems. Optimizers are fed with data about the current state and future events, and, especially in real-world applications, such data comes from automatic measurements, manual specifications, and from prediction models about the future. All these categories of data are likely to have limited accuracy. For example, measurements may come from faulty devices, manual specifications may contain mistakes and prediction models are imperfect by nature.

Informally, the robustness of an algorithm is associated with a good output quality despite limited quality of the input data. In other words, the algorithm's output is desired to degrade gracefully with the input, avoiding situations where the solution is perfect for the given input, but unacceptable when small deviations occur.

While the concept of robust optimization has been known for many decades, the last fifteen years have witnessed a substantial amount of research on this topic. At the same time, the concept of robustness has also been studied in the context of machine learning and in particular reinforcement learning. In reinforcement learning, an agent acts in an environment, receiving state information and rewards in response to its actions, and trying to learn a policy which optimizes the long-term total reward. Here, robustness is associated with mismatches between the training environment (which often is a simulation for safety reasons) and the final environment of deployment. The training procedure for robust agents copes with such mismatches by providing rewards based on pessimistic assumptions about the environment. Technically, robust reinforcement learning is realized by a second adversary agent which is learning to select, from a set of possible environment parameters, the ones where the primary agent receives minimum rewards.

Solvers for computationally hard combinatorial optimization problems often rely on heuristics, which have been designed for many decades with the goal to provide near-optimal solutions to instances of such problems within reasonable run-time. While such heuristics are traditionally designed by hand and are highly specialized to the particular problems under consideration, a recent trend in research is to employ the machine-learning pipeline for auto-designing heuristics. One of the properties of machine learning methods is that they are computationally intensive only during the training phase. Once a model has been trained, applying it to previously unseen inputs is computationally easy. This is a very desirable property for optimization in real-world scenarios like logistics. It is not a problem to train a heuristic over several hours or days fitting it to historical problem instances, but there is limited time available when applying it to new instances. Sometimes even real-time reactiveness is needed.

As in robust reinforcement learning, embodiments of the present invention set up the environment to provide pessimistic feedback to the learning agent, but, because embodiments of the present invention address combinatorial optimization with known problem specifications, the step and potential instability of training an additional adversary agent can be omitted. Embodiments of the present invention recognize that in many cases it is computationally easy to determine the worst-case problem parameters to a given solution, which is due to the continual and convex nature of the uncertainty regions. When this is not the case, it is still possible to resort to heuristics.

In the setup according to embodiments of the present invention, heuristics also play a role in the definition of the reward function. Unlike most recent work on reinforcement learning for optimization, the agents according to embodiments of the present invention do not generate a full solution from a single view of the problem instance. Instead, intermediate feedback is provided to the agent. Each action of the agent corresponds to the decision about one element of the solution (for example, the next customer to visit in a logistics routing problem), and after each step the environment state is updated to provide information about the effect of the action, and also an immediate reward is provided. This reward is constructed by using a heuristic to complete the partial solution generated by the agent so far, both before and after the most recent action has been applied. These two solutions are then evaluated by computing their cost under the respective worst-case realization of the problem parameters. The cost difference represents the amount to which the latest action has improved upon the heuristic, and this information is given to the agent as the reward.

Embodiments of the present invention interpret combinatorial problems as node sequencing problems in graphs, and use the struct2vec network architecture for the agent's value function approximation model. For the training procedure and agent architecture, an embodiment of the present invention uses the Dopamine framework, which offers a highly customizable implementation of the Deep Q-network (DQN) algorithm.

A series of experiments with the Capacitated Vehicle Routing Problem (CVRP) and the Traveling Salesperson Problem (TSP) demonstrated the effectiveness of the approach according to embodiments of the present invention. In particular, the experiments demonstrate that the trained agents are able to improve upon the baselines, constructing robust solutions using a small number of forward passes through their neural networks.

Embodiments of the present invention provide for robust optimization where the target is to identify:

$${min}_{x ∈ X} {max}_{u ∈ U} f ( x , u ) \qquad ( Equation 1 )$$

for a given problem instance. In the given instance, X is the set of feasible solutions, U is the uncertainty set of possible problem parameters, and f is the cost function. Unlike in many problem definitions provided in literature, minimization is used in an embodiment of the present invention as the default problem because it is a more common target in logistics (e.g. routing, packing, or assignment problems). This formulation is less general than the one most commonly used in combinatorial optimization literature, where also the set of feasible solutions X depends on the realization u of the uncertainty parameter. In fact, it can be easily shown that any robust optimization problem can be re-formulated so that only the feasibility constraints depend on uncertain parameters. However, the formulation above according to an embodiment of the present invention is better suited for application of reinforcement learning, and infeasibility can be dealt with either by penalizing infeasible solutions, or by interpreting the actions provided by the reinforcement learning agent in such a way that a feasible solution is always constructed. Preferably, the latter approach is used according to an embodiment of the present invention

While Equation 1 is the one definition of robust optimization used according to an embodiment of the present invention, it is not the only possible definition. Alternative formulations are less restrictive on the information under which the final solution x has to be selected. For example, in adjustable robust optimization, it is assumed that only a subset of the decisions about the solution x have to be taken before the problem parameters u become known, while the solution can be adjusted with further decisions afterwards. One particular advantage of using action selection with intermediate state updates according to an embodiment of the present invention is that the setup straightforwardly generalizes to the adjustable case.

In reinforcement learning, an agent is trained to act in an environment, learning over time how to maximize the rewards provided in response to actions. The environment can be modeled as a Markov Decision Process (MDP), which is a tuple (S, A, σ, r, p₀), where S is the set of possible environment states, A is the set of actions that can be applied by the agent in each round, σ: S×A→S is the state transition function which determines the next state after the agent has applied an action in a particular state, and the reward function r: S×A→ [symbol] determines the reward an agent receives when applying a given action in a given state. An episode is a sequence of states, actions, and rewards, starting from an initial state s₀ generated according to the given probability distribution pₒ. In each round, the agent receives from the environment the current state s ES and chooses an action a∈A. As an outcome of the action, the agent receives a reward according to the reward function, and the environment goes into the next state according to the state transition function. The episode ends when the environment is in a terminal state, which is a state where any action triggers reward 0 and transition to the identical state. While the common MDP definition does not include an explicitly given set of terminal states, computational environments like those provided by openAI gym include a flag marking states as terminal or non-terminal.

In general, the state transition function and the reward function are considered probabilistic, and most learning algorithms for reinforcement learning are designed to function under the non-deterministic case. For simplicity of notation, r and a are considered as deterministic, which actually is the case in the environments designed for robust optimization. The initial state is only considered to be chosen according to a probability distribution, which will correspond to the distribution used to generate problem instances for training and testing.

In the framework according to an embodiment of the present invention, a combinatorial problem is mapped into an MDP as follows: The environment has a set of states S, and each state s∈S is observed in form of a node- and edge-labeled graph G (s)=(V, E). Each node v∈V is associated with a vector of k node features aᵥ∈ [symbol] ^{k}. Likewise, each edge e=(u, v)∈E has a vector of l edge features bₑ∈ [symbol] ^{l}. The numbers of node and edge features, k and l, are fixed for a given environment, but the size of the graph is variable.

The action space A is associated with the set of nodes V. This means that the agent selects in each round a node from the graph it observes. While this is a slight departure from the common definition of an MDP having a fixed action set, it turns out that this does not preclude application of common reinforcement learning algorithms when learning a value function approximation which is independent of the graph size, as discussed further below.

The state transition function σ applies state changes depending on the selected action, and the observed graph changes accordingly. For example, selected nodes can be marked, traversed edges can disappear, or other meaningful information about the effect of the action can be provided as new observations.

The initial state, generated according to p₀, is associated with representations of the original problem instances before the application of any action. Further, Sₜₑᵣₘ represents the set of terminal states, associated with solved problem instances. The cost function cost: Sₜₑᵣₘ×U→ [symbol] evaluates a solution, where the evaluation is dependent on an uncertainty parameter u from the given uncertainty set U. Finally, it is assumed that there is a heuristic H:S→Sₜₑᵣₘ which simulates for any state s∈S a sequence of actions that leads to a terminal state. For s∈Sₜₑᵣₘ, it is assumed that H(s)=s. Using the cost function and heuristic, the reward function of the MDP is defined as:

$$r ( s , a ) : = {max}_{u ∈ U} cost ( H ( s ) , u ) - {max}_{{u}^{′} ∈ U} cost ( H ( T ( s , a ) ) , {u}^{′} )$$

The reward function represents the improvement achieved by the agent by selecting action a in state s and then applying the heuristic, as compared to applying the heuristic directly to s.

Thus, in the framework according to an embodiment of the present invention, an environment is determined by the set of states S, the graph representation G(s), the number of node and edge features k and l, the state transition function σ, the initial state distribution p₀, the set of terminal states Sₜₑᵣₘ, the heuristic H, the uncertainty set U, and the cost function.

With respect to value function modeling, an embodiment of the present invention uses a graph convolution neural network with the structure2vec architecture to represent a function \hat{Q}: (V, E) [symbol] \hat{Q}(v₁), . . . , \hat{Q}(vₙ) which, after training, computes the value of each action (i.e., selectable graph node). Making use of T embedding layers μ⁽⁰⁾, . . . , μ^{(T)}, each consisting of an m-dimensional embedding feature vector for each node, the following parameterized computations are performed by the network for each node v of the observed graph:

$${μ}_{v}^{( 0 )} := 0$$

$${μ}_{v}^{( t + 1 )} := relu ( {θ}_{1} {a}_{v} + {θ}_{2} {\sum }_{u ∈ N ( v )} {μ}_{u}^{( t )} + {θ}_{3} {\sum }_{u ∈ N ( v )} relu ( {θ}_{4} {b}_{( u , v )} ) )$$

$$t = 1 … T$$

$$\hat{Q} ( v ) := {θ}_{5}^{T} relu ( {θ}_{6} [ {\sum }_{u ∈ V} {μ}_{u}^{( T )} , {θ}_{7} {μ}_{v}^{( T )} ] )$$

In the second line, N(v) is the set of neighbors of v in the given graph. The computations are parameterized by an overall parameter vector Θ, consisting of matrices θ₁∈ [symbol] ^{m×k}, θ₂, θ₃∈ [symbol] ^{m×m}, θ₄∈ [symbol] ^{m×l}, θ₅∈ [symbol] ^{m×m}, θ₆∈ [symbol] ^{m×2m}, θ₇∈ [symbol] ^{m×m}, all of which are trainable. The parameter dimensionality is independent from the number of nodes and edges, which means that the training can be applied across graphs of different sizes.

For training by reinforcement learning in an embodiment of the present invention, the agents use the Q-network described above to estimate the expected return, which is the total reward over the remainder of the episode when selecting a particular node as their next action. An embodiment of the present invention employs the DQN methodology, which was introduced and became known for its impressive performance in playing ATARI games. According to the DQN methodology, the parameters Θ of the network are initialized at random, and trained from the experience the agent accumulates over the course of the training procedure. Each piece of experience is defined by a current observation (graph) G, the action a chosen by the agent, the reward r received in response, and the follow-up observation G′ provided by the environment. For every step performed by the agent, one such sample of experience is collected and stored in the replay memory. For learning the Q-function, the agent retrieves in regular intervals a number of samples (G, a, r, G′) from the replay memory and uses them for training.

The Q-network is trained using the Bellman Equation:

$${Q}^{*} ( G , a ) = r + γ {max}_{{a}^{′} ∈ A} {Q}^{*} ( {G}^{′} , {a}^{′} )$$

The right-hand side of the Bellman Equation serves as the target against which the training loss of the current Q-network is computed. As the target depends on the true optimal Q-function, it can only be approximated. The approximation is realized by plugging in a frozen version of the Q-network trained so far, and this frozen version is updated to the latest learned version in regular intervals (e.g., after 10,000 training steps). The discount factory γ∈[0, 1] is a hyper-parameter which controls how much attention the agent pays to future rewards beyond the next step. While navigating in the environment, the agent follows the recommendation of its Q-network with probability 1−ϵ, and, for exploration purposes, the agent selects a random action with probability E.

As mentioned above, one of the experiments demonstrating the computational improvements achieved by embodiments of the present invention was based on the CVRP, a central problem in logistics. Here, there is given a set of customers, each associated with a node v of a common graph. Each customer has a demand dᵥ, which can be represented as the size of a parcel that needs to be picked up from the customer. A special graph node v₀ serves as the depot, and vehicles, each having the same capacity (normalized to 1 in the model), can be dispatched from the depot to serve a sequence of customers and then return to the depot. The total demand served on such a tour must not exceed the vehicle capacity. The target is to find a set of tours such that all customer demands are served and the total distance travelled is minimized.

The distance travelled by the vehicles is determined by the pairwise distances between the nodes, and this quantity is considered to be uncertain: A number of edges can have a travel distance larger than specified, e.g., due to traffic jams. More specifically, the uncertainty set is parameterized by the deviation rate α and the deviation factor β. If n is the number of nodes in a given graph, up to └α·n┘ edges can have a distance which is by a factor of up to β larger than specified. The experiments used α=0.3 and β=2.

To represent (partially solved) problem instances as a graph, seven node features and one edge feature were employed. The edge feature represents the distance between the connected nodes. The node features are: (0) a binary feature representing whether the node exists or is a dummy (see below for explanation), (1,2) two-dimensional node coordinates, (3) the node demand, (4) binary feature representing whether the node is the depot, (5) binary feature representing whether the node has been already visited, (6) binary feature representing whether the node is part of the tour currently under construction.

Node feature (0) is used in an embodiment of the present invention for a technical reason: the implementation makes use of the openAI gym environment, which assumes a fixed state and action space in any instantiation of an environment. Thus, during training the node set needs to be filled up with dummy nodes. Node feature (6) reflects the way the environment interprets nodes selected by the agent: tours are constructed one by one, and whenever the agent selects a node, it is integrated (e.g., inserted at the cheapest possible position) into the tour currently under construction. The tour is ended and a new tour is started as soon as the selected node cannot be integrated into the active tour without exceeding the capacity.

Two completion heuristics for CVRP were implemented. The “Greedy” heuristic adds at each step the node to the current tour which can be inserted at minimal cost. Whenever there is no such node because of the capacity constraint, the current tour is ended and a new tour is started. The “AngleSorting” heuristic sorts the nodes by the angle of the direction to reach them from the depot. Nodes are added to the current tour in that order, and, whenever a node cannot be accommodated into the current tour, a new tour is started. Both heuristics do not take into account the uncertainty when taking decision. Thus, it is up to the learning agent to understand the effects of its actions in light of the pessimistic evaluation.

The difference between the CVRP and the TSP is that, in the latter, there are no vehicle capacity constraints, so all nodes can be visited in a single tour, and the objective is to minimize the tour length. For both problems, equivalent definitions of the uncertainty regions were applied with a deviation rate α=0.3 and deviation factor β=2. For each of the two problems, the experiments used several datasets, consisting of instances of several sizes (15-20 nodes, 40-50 nodes, 90-100 nodes, 200-300 nodes). Independent training and test sets were generated for each of the four size classes. The node coordinates were generated uniformly from the unit square, while the node demands were obtained by squaring uniform numbers from the interval [0, 1]. For scalability reasons, the number of outgoing edges per node (in the state information provided to the agent) was restricted to the ten nearest neighbors. For TSP, instances were generated using the same principles, except for the demand, which does not play a role here. Each training and test set consisted of 1,000 instances.

With respect to hyperparameter configuration, for the CVRP agents, the AngleSorting completion heuristic was applied, whereas the Greedy completion heuristic was applied for agents trained on TSP instances. These choices were based on observations made during a set of initial experiments. The agents train Q-networks using two embedding layers with 64 embedding features each. The training procedure used within the Q-learning framework is gradient descent with the learning rate set to 0.003. The DQN procedure was set to use a replay memory of size 5,000, which is small compared to typical applications, but sufficient for the experiments. The discount factor γ was set to 0.9, and the exploration rate E was set to decay linearly from 1.0 to the final value of 0.1 over 500,000 training steps.

The approach according to an embodiment of the present invention was compared with two baselines. One baseline algorithm, referred to as the “Greedy” baseline, applies the Greedy completion heuristic to the original instances. The second baseline algorithm, referred to as the “MathProg” baseline, approaches the robust CVRP by adopting the k-adaptability method in two-stage robust optimization. Computational efficiency and optimality property of this approach in solving robust optimization models has been confirmed in a number of studies. An oracle-polynomial algorithm was used to solve the min-max-min problem for CVRP. In this method, the max-min problem is defined as a linear maximization problem, which is actually the dual of the restricted version of the main model having a convex feasibility region. This dual model is updated at every iteration by adding more constraints based on solutions to the master minimization problem. Since the dual model can be optimized easily, performance of the robust optimization algorithm improves considerably, which is the main reason to use this method as a baseline. The MathProg robust CVRP solver consists of two base solvers: 1) a CVRP heuristic (Clarke and Wright savings heuristic), which computes a solution to the CVRP problem given a specific realization of the uncertainty; and 2) a linear programming solver that computes the worst uncertainty parameter based on the output of the previous solver.

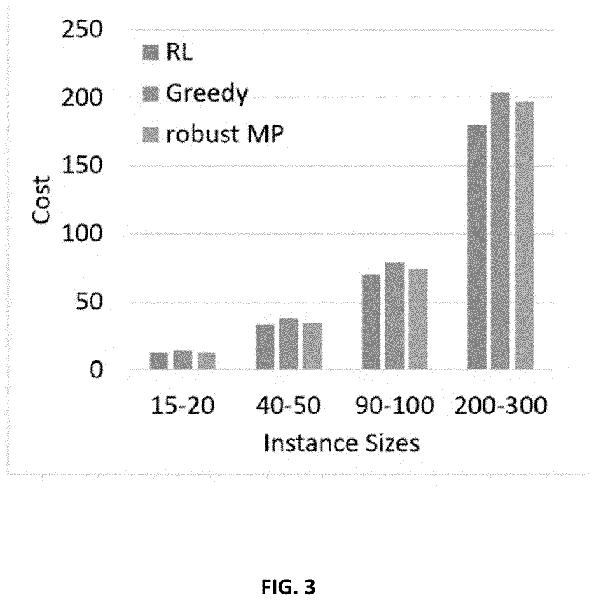

FIGS. 3-7 illustrate results of the experiments and show the worst-case costs max_{u∈U}cost(x, u) for the computed solutions x.

FIG. 3 depicts the performance of the reinforcement learning method according to an embodiment of the present invention and the baselines on test instances of various sizes. The agents are trained on instances of comparable sizes and evaluated on independent test sets. FIG. 3 reports the worst-case costs, averaged over all 1,000 test instances of the respective size classes. In FIG. 3, the reinforcement learning method according to an embodiment of the present invention is designated RL and is the first column for each of the size classes (15-20 nodes, 40-50 nodes, 90-100 nodes, 200-300 nodes), while the two baselines are designated Greedy and robust MP and are respectively the second and third columns for each of the size classes (15-20 nodes, 40-50 nodes, 90-100 nodes, 200-300 nodes). FIG. 3 shows that trained agent according to an embodiment of the present invention outperforms the two baselines by at least a few percent on all size classes, with the greatest improvements being obtained at the largest size class.

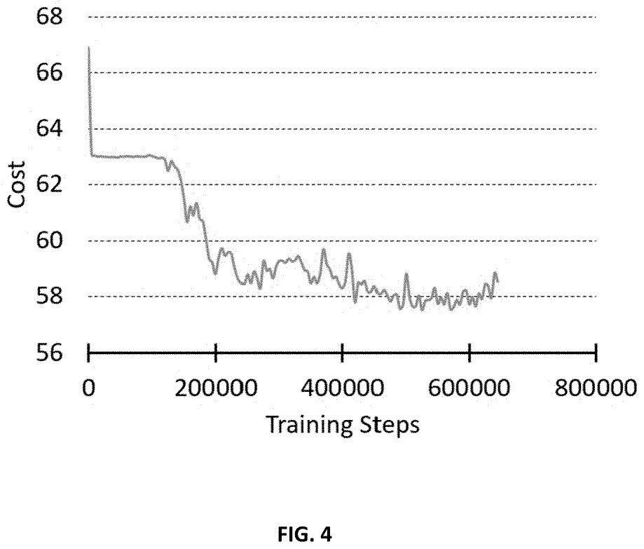

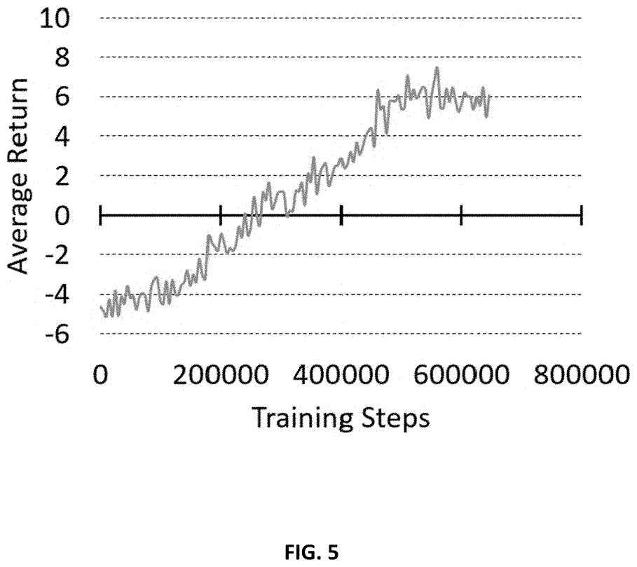

Further insight on what happens during the training procedure is provided in FIGS. 4 and 5. In FIG. 4, the cost obtained from applying the agent to the independent test set over the course of 700,000 training steps is depicted. It is a typical behavior that the performance first plateaus for some period, before it starts to improve and finally converges to a better performance. FIG. 5 shows the average return (i.e., rewards summed up per episode) of the agent during training. The rewards are defined as the improvement over the completion heuristic. FIG. 5 shows how the agent first performs worse than the heuristic, obtaining negative returns, and after some training begins to outperform it and obtain positive returns.

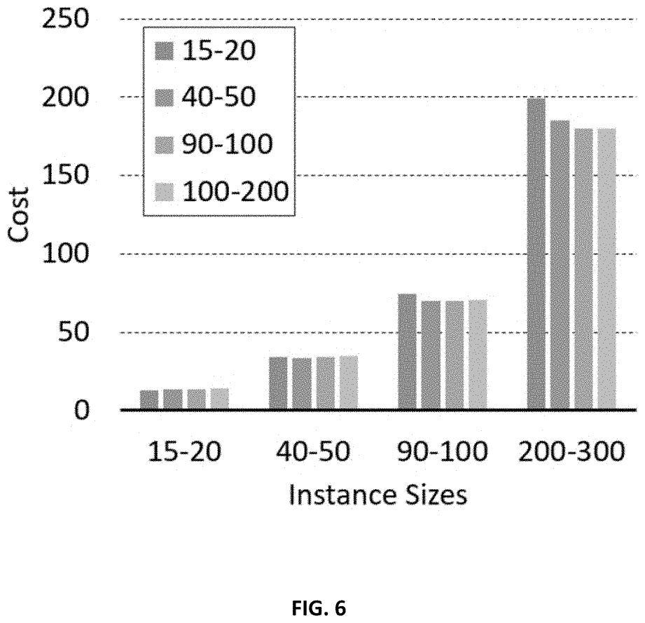

The generalization capacity of the trained agents according to an embodiment of the present invention to instances having sizes other than the ones in the training set was also evaluated. For this purpose, each of the four CVRP agents, trained on the four size classes, were tested on each of the test sets. The results are depicted in FIG. 6, wherein for each of the different instance sizes in the test set on the horizontal axis (15-20 nodes, 40-50 nodes, 90-100 nodes, 200-300 nodes), the columns for the agents trained on the four size classes are, from left to right, the agent trained on 15-20 nodes, the agent trained on 40-50 nodes, the agent trained on 90-100 nodes and the agent trained on 200-300 nodes. For each test set, the agent trained on the respective training set performs best, and the agent trained on the smallest instances does not generalize well. For the other agents, the performance is close to the “specialists” for the respective instance sizes.

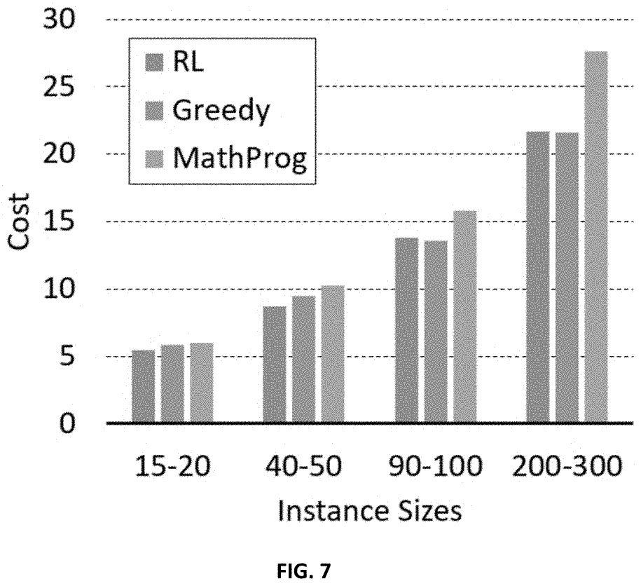

FIG. 7 graphically demonstrates results on robust TSP problem instances of various size classes using the Greedy completion heuristic, wherein the agent according to an embodiment of the present invention has been trained on instances of various sizes and evaluated on independent test sets with comparable instances. The results of the evaluation of the TSP agents demonstrate that the baselines are outperformed by the trained agents according to an embodiment of the present invention for larger instances. It was also observed that for smaller instances a better performance is exhibited when using the AngleSort completion heuristic. In FIG. 7, the reinforcement learning method according to an embodiment of the present invention is designated RL and is the first column for each of the size classes (15-20 nodes, 40-50 nodes, 90-100 nodes, 200-300 nodes), while the two baselines are designated Greedy and MathProg and are respectively the second and third columns for each of the size classes (15-20 nodes, 40-50 nodes, 90-100 nodes, 200-300 nodes).

Thus, the experiments demonstrate the computational improvements in obtaining solutions to combinatorial optimization problems that are more robust against instabilities using agents trained using reinforcement learning according to an embodiment of the present invention, in particular using feedback from pessimistic evaluations of the generated solutions. The solutions have a good quality in face of uncertainty, and result in lower worst-case costs for the technical application.

Further embodiments of the present invention can address adjustable robust optimization, where the agents' actions will be used both for solution construction and for adjusting the solution after the environment has revealed some or all of its uncertain parameters.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for generating robust solutions to optimization problems using machine learning, the method comprising:
a) receiving an instance of an optimization problem;
b) computing a solution to the instance using a model;
c) generating a cost-maximizing environment realization for the solution; and
d) using a cost of the solution in the cost-maximizing environment realization for the solution as feedback to update the model.

2. The method according to claim 1, wherein steps a)-d) are repeated to train the model until convergence is reached.

3. The method according to claim 2, further comprising deploying the trained model to generate solutions to new problem instances.

4. The method according to claim 2, wherein the cost-maximizing environment realization for the solution is determined using a supervised learning model for at least some of the iterations of step c), and wherein the supervised learning model has been trained using input-output pairs including uncertainties of the optimization problem and different solutions to the optimization problem as input and cost-maximizing environment realizations for the different solutions to the optimization problem as output.

5. The method according to claim 2, further comprising determining the instance for at least some of the iterations of step a) using a history of problem instances stored in an instances history database.

6. The method according to claim 5, wherein at least some of the instances are generated using a generative model trained using the history of problem instances stored in an instances history database.

7. The method according to claim 1, further comprising repeating steps a) and b) and tracking a state for the solution, wherein, for at least some of the iterations of steps a) and b), the solution is a partial solution to the instance of the optimization problem.

8. The method according to claim 7, wherein the feedback is a reward of zero until a full solution to the instance is obtained, at which point the feedback is a negative reward based on the cost of the solution in the cost-maximizing environment realization for the solution.

9. The method according to claim 1, wherein the solution is a partial solution, the method further comprising using a frozen version of the model to generate remaining steps to a full solution, wherein the feedback for the partial solution is the cost of the full solution in the cost-maximizing environment realization for the full solution.

10. The method according to claim 1, wherein the optimization problem is a logistics problem.

11. The method according to claim 10, further comprising:
selecting a vehicle to be an active vehicle;
selecting a demand in the instance;
modifying the instance based on whether the active vehicle has sufficient capacity for the demand; and
using Monte-Carlo rollouts to provide the feedback.

12. The method according to claim 1, further comprising using a heuristic to generate a default solution, wherein a cost difference between a cost of the default solution in a cost-maximizing environment realization for the default solution and the cost of the solution in the cost-maximizing environment realization for the solution is used as the feedback.

13. The method according to claim 1, wherein the cost-maximizing environment realization for the solution is formulated as a linear problem and determined using a linear programming solver.

14. A computer system for training a reinforcement learning agent to generate robust solutions to optimization problems using machine learning, the system comprising one or more hardware processors which, alone or in combination, are configured to provide for execution of the following steps:
a) receiving an instance of an optimization problem;
b) computing a solution to the instance using a model;
c) generating a cost-maximizing environment realization for the solution; and
d) using a cost of the solution in the cost-maximizing environment realization for the solution as feedback to update the model.

15. A tangible, non-transitory computer-readable medium having instructions thereon which, upon being executed by one or more processors, alone or in combination, provide for execution of the following steps:
a) receiving an instance of an optimization problem;
b) computing a solution to the instance using a model;
c) generating a cost-maximizing environment realization for the solution; and
d) using a cost of the solution in the cost-maximizing environment realization for the solution as feedback to update the model.
